(19) United States
(12) Patent Application Publication
(10) Pub. No.: US 2002/0174937 A1
(43) Pub. Date: Nov. 28, 2002

(54) Methods and apparatus for manufacturing patterned ceramic green-sheets and multilayered ceramic devices

(75) Inventors: Jeremy W. Burdon, Scottsdale, AZ (US); David L. Wilcox, Chandler, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/953,664

(22) Filed: Sep. 13, 2001

Related U.S. Application Data
(63) Continuation-in-part of application No. 09/865,330, filed on May 25, 2001.

(51) Int. Cl. C03B 29/00

(52) U.S. Cl. 156/89.12

(57) ABSTRACT

Cast-on-resist (COR) methods and apparatus are provided for forming green-sheets. The COR method is comprised of depositing a resist (102) on a substrate (104) and selectively exposing the resist (102) to a radiation source such that a first portion (106) of the resist (102) having a positive image of the pattern is soluble in a solvent and a second portion (108) of the resist (102) having a negative image of the pattern is insoluble in the solvent. The COR method is also comprised of immersing the resist (102) in the solvent to remove the first portion (106) to form a casting substrate (100) having the negative image of the pattern, applying ceramic slurry (212) on the casting substrate (100), curing the ceramic slurry (212) on the casting substrate (100), and removing the ceramic slurry (212) from the casting substrate (100) after the curing.

### FIELD OF THE INVENTION

The present invention relates to a multilayered ceramic device. More particularly, this invention relates to methods and apparatus for manufacturing patterned green-sheets and multilayered ceramic devices.

### BACKGROUND OF THE INVENTION

Multilayered ceramic devices have a wide variety of electronic, chemical and biological applications. Generally, multilayered ceramic devices with isolated connections are used as a component in a wide variety of mechanical, electrical, biological and/or chemical devices. For example, a multilayered ceramic device with isolated connections can be used as a component in a Multilayered Microfluidic Device (MMD) that is configured to mix, react, meter, analyze and/or detect chemical and biological materials in a fluid state (i.e., gas or liquid state).

Various methods have been used to form micro features in a ceramic layer, which is commonly known as a green-sheet, that forms one of the layers of a multilayered ceramic device, such as a MMD. For example, a mechanical ceramic punch can be configured to punch out portions of a green-sheet, an embossing plate having a negative image of a pattern can be pressed against a green-sheet to imprint the pattern, or laser tooling can be used to form a pattern in the green-sheet. However, these methods have a limited ability to provide stable, compact multilayered ceramic devices with precise micro feature dimensions and/or a wide variation in micro feature aspect ratios. This is especially true when the size of the micro feature is less than about ten microns. Furthermore, mechanical punching and laser tooling do not typically provide partially recessed patterns within a green-sheet. Rather, they are generally limited to the formation of complete through-hole micro features. Hence, the depth of the micro feature is restricted to the total thickness of the green-sheet. Accordingly, it is necessary to separate an integrated thick-film function from the desired micro feature by at least one green-sheet layer. In addition, micro features having more than two sides and/or a closed micro features, such as a TESLA valve cannot be easily processed due to the lack of structural support.

Several methods are known for forming a partially recessed pattern within a green-sheet layer. For example, a green-sheet is pressed onto a mold having recessed patterns. Due to the fact that green-sheets are dense, this method may not produce satisfactory results, especially when the micro features are less than about ten microns. In order to achieve acceptable final fired density in the MMDs, this method requires the use of high solids loading in the green-sheet which limits its deformation under an uniform, controlled condition. In addition, laser or electron beam radiation through a mask has been used to form recessed patterns on a green-sheet layer. This method is effective, but requires expensive and delicate machinery applied under carefully controlled conditions.

In view of the foregoing, it is desirable to provide simple and more cost effective methods to manufacture patterned green-sheets and multilayered ceramic devices. Furthermore, additional desirable features will become apparent to one skilled in the art from the drawings, foregoing background of invention and following detailed description of preferred embodiments, and appended claims.

### BRIEF DESCRIPTION OF THE DRAWINGS

FIG. 1 illustrates a cast-on-resist (COR) sequence of forming a casting substrate according to a preferred exemplary embodiment of the present invention;

FIG. 2 illustrates a COR batch processing apparatus that is configured to manufacture patterned green-sheets according to a preferred exemplary embodiment of the present invention;

FIG. 3 illustrates a plastic deformation of a patterned green-sheet according to a preferred exemplary embodiment of the present invention;

FIG. 4 illustrates a green-sheet having at least one recessed pattern according to a preferred exemplary embodiment of the present invention;

FIG. 5 illustrates microfluidic features formed according to a preferred exemplary embodiment of the present invention;

FIG. 6 illustrates a Multilayered Microfluidic Device (MMD) according to a preferred exemplary embodiment of the present invention;

FIGS. 7A-7F are partial views of the MMD of FIG. 6 according to a preferred exemplary embodiment of the present invention; and

FIG. 8 illustrates a method for forming a MMD according to a preferred exemplary embodiment of the present invention.

### DETAILED DESCRIPTION OF THE PREFERRED EMBODIMENTS

The following detailed description of preferred embodiments is merely exemplary in nature and is not intended to limit the invention or the application and uses of the invention.

The methods and apparatus for forming a multilayered ceramic device with at least one and preferably multiple recessed patterns or micro features can be utilized to form any number of configurations and/or structures such as vias, channels, and cavities. As used herein, the term “via” refers to an aperture formed in a green-sheet layer. Typical vias have diameters ranging from twenty-five to five hundred microns. However, vias can have diameters less than twenty-five microns to diameters approaching photolithographic limits (i.e., one micron). Vias can also be filled in subsequent steps with other materials, such as thick-film pastes. Furthermore, as used herein, the term “channel” refers to an open region within a multilayered structure that has a length that is greater than a width. Typical channels have cross-sections ranging from twenty-five microns to five hundred microns. However, channels can have cross-sections less than twenty-five microns to diameters approaching photolithographic limits (i.e., one micron). In a MMD of the present invention, channels are typically used to transfer fluid materials. “Channels” may also be referred to as “capillaries” or “conduits.” In addition, as used herein, the term “cavity” or “well” refers to a hole, aperture or an open area. Cavities are typically used to contain, mix, react, or transfer fluid materials. Generally, cavities are connected to a channel or via to provide input or output of material and the cavity has dimensions greater than the channel or via.

Referring to FIG. 1, a cast-on-resist (COR) sequence is illustrated for forming a casting substrate 100 that can be used in a further manufacturing process to form a green-sheet 200 with a recessed pattern according to a preferred exemplary embodiment of the present invention. The COR method begins with the depositing of a layer of sensitive material 102 on a substrate 104. The substrate 104 can be any number of materials that can accept ceramic slurry, provide a structural support for the layer of sensitive material 102 and/or does not strongly adhere to ceramic slurry (i.e., allows the separation of a green-sheet from the casting substrate 100 as subsequently described in this detailed description of preferred embodiments). For example, the substrate 104 can be MYLAR® sold by DuPont Teijin Films, polyethylene sheet, polypropylene sheet, or tape-casting paper.

The layer of sensitive material 102, which is commonly referred to as a resist, can be any number of resists that are soluble or insoluble in a solvent after exposure to a radiation source (not shown). In this detailed description of a preferred exemplary embodiment, the layer of sensitive material 102 is a positive resist that is soluble in a solvent after exposure to a radiation source. However, a negative resist, which is insoluble in a solvent after exposure to a radiation source, can be used in accordance with the present invention.

Once the layer of sensitive material 102 is deposited on the substrate 104, a microlithography process is used to selectively expose the layer of sensitive material 102 to a radiation source (not shown) such that a first portion 106 of the layer of sensitive material 102 having a negative image of the recessed pattern is insoluble in a solvent and a second portion 108 of the layer of sensitive material 102 having a positive image of the recessed pattern is soluble in the solvent. The selective exposure of the layer of sensitive material 102 can be accomplished using any number of techniques. For example, a mask with opaque and transparent regions corresponding to the first portion 106 and the second portion 108 of the layer of sensitive material 102, respectively, is placed between the radiation source and the layer of sensitive material 102 and the radiation source is activated to expose (e.g., radiate) the second portion 108 below the transparent region of the mask.

The radiation source can be any number of sources that affect the solubility of the layer of sensitive material 102, such as an ultraviolet (UV) light, x-rays and/or electron beams. For example, in a photolithographic process that utilizes UV light as the radiation source, a polymer-based positive resist can be selectively exposed to UV light, which creates cross-polymerizing bonds in the resist through photo activation such that the exposed resist is soluble to an organic solvent while unexposed resist is insoluble to the organic solvent.

After the layer of sensitive material 102 is exposed to the radiation source and any additional developmental activities are performed to develop the layer of sensitive material 102 such that the first portion 106 of the layer of sensitive material 102 is insoluble and the second portion 108 of the layer of sensitive material 102 is soluble, the layer of sensitive material 102 is immersed in the solvent (not shown) (e.g., spraying the solvent over the surface of the resist) to remove the second portion 108 of the layer of sensitive material 102.

It should be appreciated that the deposition and patterning of the layer of sensitive material 102 onto the substrate 104 previously described in this detailed description of preferred embodiments can be accomplished with any number of techniques and variations, and two examples of these steps are provided in Appendix 1 and Appendix 2. However, it should be understood that the present invention is not limited to the methods described in Appendix 1 and Appendix 2.

While processes of the prior art would subsequently immerse the layer of sensitive material 102 (e.g., resist) and/or the substrate 104 in a solution to remove exposed portions of the substrate 104 (i.e., portions of the substrate 104 that do not have a layer of sensitive material 102) and subsequently remove the layer of sensitive material 102 with additional chemical processes, the COR method of the present invention does not etch the substrate 104 or remove the layer of sensitive material 102. Rather, the substrate 104 and the layer of sensitive material 102 are configured to form a casting substrate 100 or casting mold having the negative image of the recessed pattern provided by the first portion 106 of the layer of sensitive material 102. It may be desirable to coat the layer of sensitive material 102 with a release layer (not shown (e.g., silicone) to lower the surface energy. This will enhance the ability to separate the green-sheet 200 from the casting substrate 100 during subsequent manufacturing process.

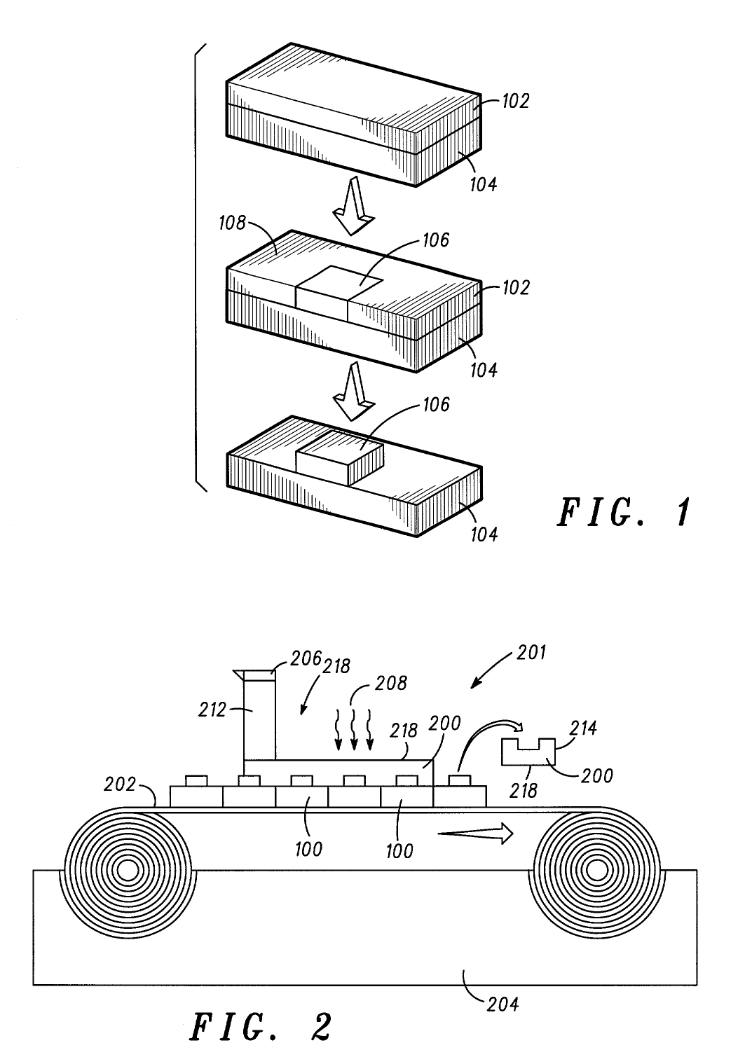

Referring to FIG. 2, a COR batch processing apparatus 201 is illustrated for manufacturing patterned green-sheets 200 according to a preferred exemplary embodiment of the present invention. Once multiple casting substrates 100 having the negative image of the recessed pattern provided by the first portion 106 of the layer of sensitive material 102 are formed by the COR method described with reference to FIG. 1, the multiple casting substrates 100 are connected to a tape casting sheet 202 of a conveyor or functionally equivalent transporting system (not shown) of a tape casting system 204. Examples of a suitable tape-casting sheet 202 include MYLAR®, polyethylene sheet, polypropylene sheet, or tape-casting paper. Examples of a suitable tape casting system 204 includes Unique/Pereny Pro-Cast Series Precision Casting/Coating Machines sold by HED International and Palomar MSI Mark 155 sold by Palomar Systems and Machines, Inc.

The tape casting system 204 transports the multiple casting substrates 100 through a curtain of ceramic slurry 212 dispersed by a curtain-coating machine 206 at a controlled rate and substantially over the width of a coating head of the curtain-coating machine 206. By controlling the flow rate of the ceramic slurry 212 and the velocity of the multiple casting substrates 100 passing through the curtain of ceramic slurry 212, a desired thickness of the deposited ceramic slurry 212 is obtained. An example of a suitable curtain-coating machine 206 is the Curtain Coater sold by Koating Machinery Company, Inc. Alternatively, the ceramic slurry 212 is applied on each of the multiple casting substrates 100 with any number of other techniques and apparatus, such as by doctor blading (not shown).

The ceramic slurry 212 is preferably a composite material comprised of ceramic particles and inorganic particles of glass, glass-ceramic, ceramic, or mixtures thereof dispersed in a polymer binder with solvent, a polymer emulsion, or a curable binder and can also include additives such as plasticizers and dispersants. If a curable binder is used as a part of the ceramic slurry 212, then it is less desirable for the ceramic slurry 212 to contain solvent. As subsequently discussed in this detailed description of preferred embodiments, the use of a curable binder in place of a polymer binder with solvent minimizes transfer of the recessed pattern to the top surface 218 of green-sheet 200 during the curing process.

The ceramic particles are typically metal oxides, such as aluminum oxide or zirconium oxide. The composition of the ceramic slurry 212 can be custom formulated to meet particular applications. For example, applications with desired high temperature stability (>1000° C.) can use material systems incorporating Al₂O₃ with very low (<2%) glass. For applications preferably having an oxygen-ion conduction component, zirconia can be utilized to meet this particular application. For applications preferably having high conductivity metals, such as silver, glass-ceramics systems are used that can be co-fired with the silver metallizations at temperatures below the melting point of silver.

Components of the glass can also be tailored to provide specific properties. For example, glass that crystallizes during the subsequently described sintering process can have the advantage of providing additional mechanical support or the chemistry of the glass phases and their reaction with ceramic phases in the system can yield specific crystalline phases with desired electrical and electromagnetic performance. Some typical glass systems are lithium-aluminosilicate (Li₂O—Al₂O₃—SiO₂), magnesium-aluminosilicate (MgO—Al₂O₃—SiO₂), sodium or potassium borosilicate (Na/K SiO₂—B₂O₃) In fact, green-sheets 200 composed of metals such as silver, palladium-silver, gold for Low Temperature Co-fired Ceramic (LTCC) or molybdenum, tungsten, and other refractory metals for High Temperature Co-fired Ceramic (HTCC) systems could be used to attain layered metal structures.

After ceramic slurry 212 is applied on the casting substrates 100, the ceramic slurry 212 is cured with a curing apparatus 208 to provide a green-sheet 200 having the recessed pattern that is formed as the ceramic slurry 212 substantially conforms to the casting substrate 100 that includes the remaining portion (i.e., the first portion 106) of the layer of sensitive material 102 as shown in FIG. 1. The curing of the ceramic slurry 212 with the curing apparatus 208 to provide the green-sheet 200 can be accomplished with any number techniques that are specific to the ceramic slurry 212. For example, the curing of the ceramic slurry 212 can be conducted with a heating, drying, UV irradiation and/or aging process in order to remove volatile organic compounds and/or to polymerize the binding agent.

The ceramic slurry 212 is preferably applied and cured to provide a layer thickness 214 between about fifty microns to about two hundred and fifty microns. However, any layer thickness can be provided in accordance with the present invention. The composition and thickness of the green-sheet 200 can be custom formulated to meet particular applications. Techniques for casting and curing ceramic slurry 212 into a green-sheet 200 are described in Richard E. Mistler, “Tape Casting: The Basic Process for Meeting the Needs of the Electronics Industry,” Ceramic Bulletin, vol. 69, no.6, pp. 1022-26 (1990), and in U.S. Pat. No. 3,991,029, which are incorporated herein by reference.

After the ceramic slurry 212 is cured on the casting substrates 100 to provide a green-sheet 200 having the recessed pattern that is formed as the ceramic slurry 212 conforms or molds to the casting substrate 100, the green-sheet 200 is removed from the casting substrate 100 such that the green-sheet 200 with the recessed pattern is separated from the casting substrate 100. However, the green-sheet 200 having the recessed pattern can remain on the casting substrate 100 through any number of additional processes or can be removed from the casting substrate 100 after curing. The removal of the green-sheet 200 with the recessed patterned should be accomplished so that the shapes and/or contours of the recessed pattern remain substantially intact. Often, the green-sheet 200 is cut into six inch-by-six inch squares for processing. Although the green-sheet 200 can be removed by peeling, the green-sheet 200 is preferably attached to a vacuum table (not shown) and secured while the casting substrate 100 is removed, thereby preventing any potential distortion of the green-sheet 200.

Some of the conventional curing techniques, such as heating to remove the plasticizers may cause a transfer of the recessed pattern to the top surface 218 of the green-sheet 200. Therefore, the present invention preferably minimizes transfer of the recessed pattern to the top surface 218 of the green-sheet 200. The minimizing of the transfer of the recessed pattern to the top surface 218 of the green-sheet 200 can be accomplished according to the present invention with a curable binder system (e.g., a photopolymerizable acrylate monomer cured under UV irradiation). Exemplary curable binder systems are described in T. Chartier, C. Hinczewski, and S. Corbel, “UV Curable Systems for Tape Casting,” Journal of European Ceramic Society, 19 (1999), pp. 67-74. The utilization of a curable binder system can reduce shrinkage of the ceramic slurry 212. As can be appreciated, the curable binder will undergo minimal shrinkage during curing, as the solvents are not removed by drying. Rather, monomers and/or oligomers in the ceramic slurry 212 cross link through thermal or photochemical means. Thus, pattern transfer to the top surface 218 of the green-sheet 200 is significantly reduced with the addition of the curable binder system.

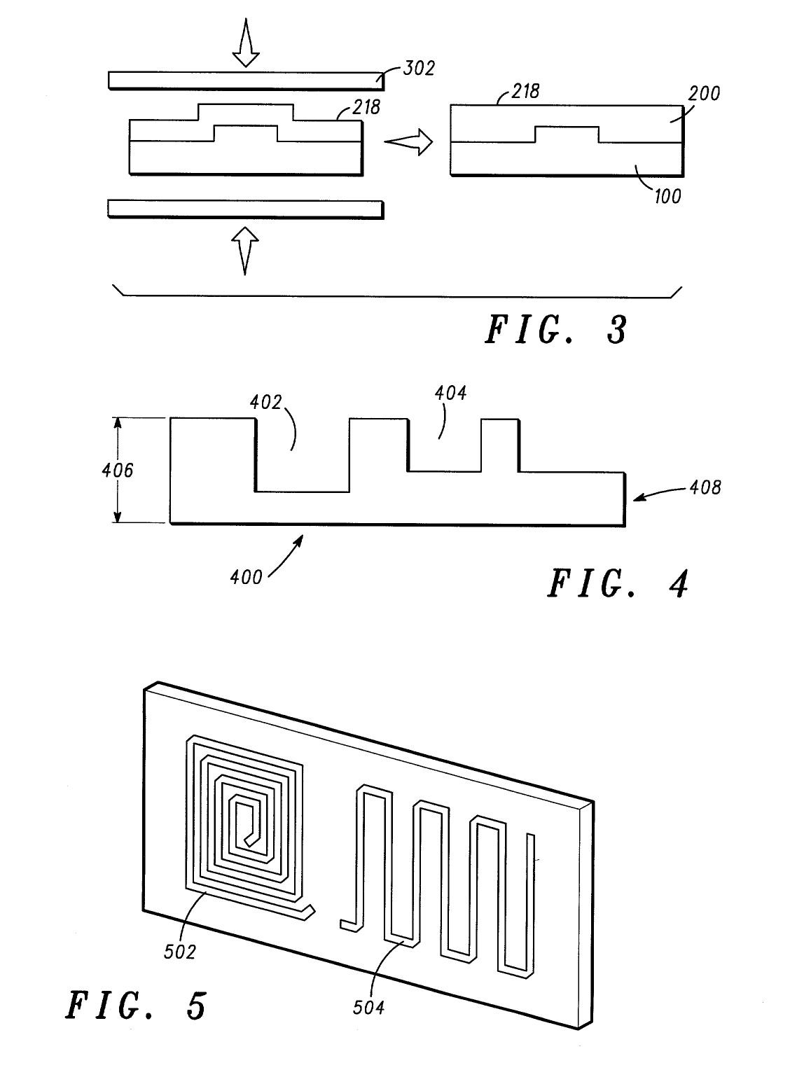

Minimizing the transfer of the recessed pattern to the top surface 218 of the green-sheet 200 can also be accomplished according to the present invention with plastic deformation of the green-sheet 200 while it is still on the casting substrate 100. As shown in FIG. 3, a uniaxial press or calender 302 is configured to apply pressures and temperatures (e.g., temperature ranges from 50° C. to 100° C., pressure ranges from 250 psi to 1500 psi for conventional LTCC ceramic layers) to level or planarize the top surface 218 of the green-sheet 200. This process is similar to the process used for leveling a green-sheet 200 after screen-printing features onto the surface of the green-sheet 200. In addition to leveling or planarizing the top surface 218 of the green-sheet 200, plastic deformation can also be utilized to reduce the height of the recessed patterns or micro features contained within the green-sheet 200.

As can be appreciated from the foregoing detailed description, a green-sheet 200 with the recessed pattern is available for incorporation into a multilayered ceramic device. As subsequently described in greater detail, the recessed patterns or apertures in the green-sheet 200 can be used to form micro-features such as vias, channels, and cavities. In addition, thick-film technology can be employed to incorporate conductors and dielectrics into the multilayered ceramic device.

For example, vias and channels can be formed during the casting process, thereby minimizing collateral processing damage. In addition, as shown in FIG. 4, the depth of a micro feature in the green-sheet 400, such as a first channel 402 and a second channel 404, is less restricted by the thickness 406 of the green-sheet 400 because the micro feature no longer extends through the entire thickness of the green-sheet. Furthermore, an integrated thick film function can be located in relatively close proximity to the micro feature, which aids in heat transfer and temperature control. As can be appreciated by one of ordinary skill in the art, this is a desirable feature for biological applications as many biological reactions a resolution that is about less than or equal to one degree Celsius (i.e., resolution is less than or equal to 1° C.).

The size of the micro feature can also be controlled in the one hundred micron to ten-micron range to photolithographically defined resolution, which provides a substantially greater resolution than pattern imprinting techniques of the prior art. For example, precise definition can be achieved for micro features that are greater than about one hundred microns or less than about ten microns. Also, exposed edges of micro features and wall surfaces can be controlled as compared to the control provided with techniques of the prior art, including conventional pattern imprinting methods. Micro features with curved surfaces can be formed without stepped or jagged edges. In addition, numerous microfluidic features can be formed without the use of expensive and delicate laser or electron beam radiation machinery. For example, microfluidic features (502,504) can be formed as shown in FIG. 5.

Once the individual green-sheets are formed with the recessed patterns using the COR methods and apparatus of the present invention, further processing is preferably conducted to form multilayered ceramic devices. For example, further processing is preferably conducted to form an MMD. An MMD would normally include, in addition to a fluid passageway, components that enable interaction with a fluid. Such components fall into three broad classes: (1) components that facilitate physical, chemical, or biological changes to the fluid such as heaters, thermoelectric elements, heterogeneous catalysts, and other elements that are used for cell lysing; (2) components that allow the sensing of various characteristics of the fluid such as capacitive sensors, resistive sensors, inductive sensors, temperature sensors, pH sensors; and optical sensors; (3) components that control the motion of the fluid such as electroosmotic pumps, electrohydrodynamic pumps, and pumping using piezoelectric members or electromagnets. These component classes and a detailed description of the formation of an MMD with multiple ceramic layers are provided in International Patent Application No. PCT/US99/23324 titled “Integrated Multilayered Microfluidic Devices and Methods for Making the Same,” filed by Motorola, Inc. on Oct. 7, 1999 and published on Apr. 20, 2000, having a International Publication No. WO 00/21659, which is incorporated herein by reference; and in U.S. patent application Ser. No. 09/235,081 titled “Method for Fabricating a Multilayered Structure and the Structures Formed by the Method,” filed by Motorola, Inc. on Jan. 21, 1999, which is incorporated herein by reference and hereinafter referred to as the “Integrated MMD reference”.

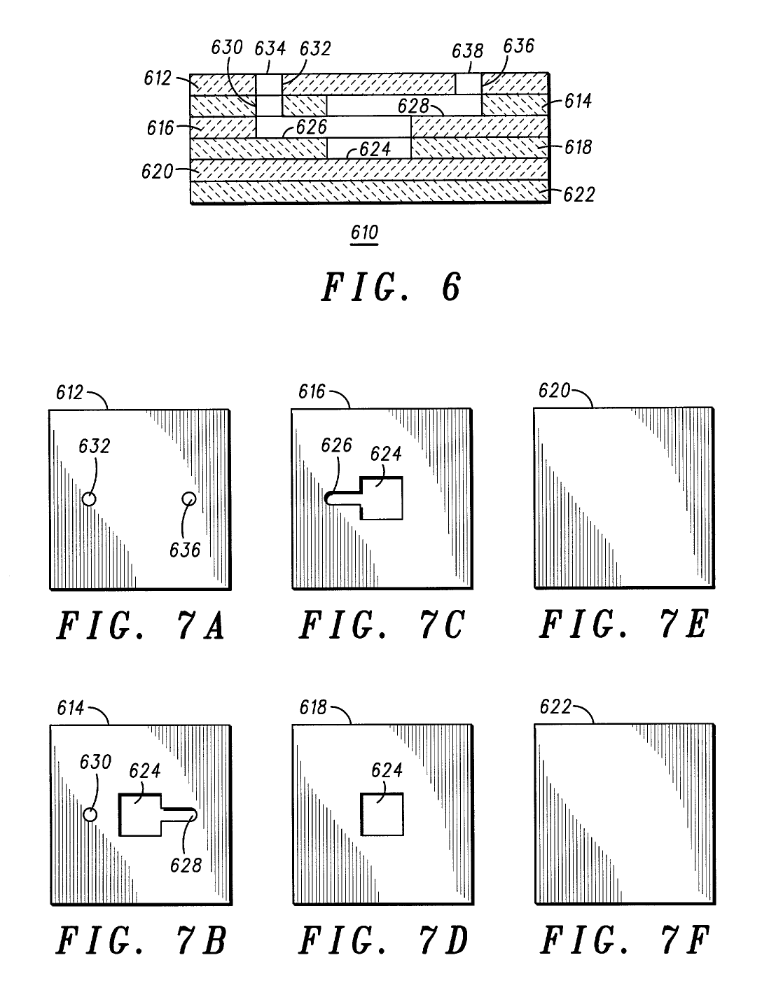

Referring to FIG. 6, a MMD 610 is illustrated with multiple COR patterned ceramic (green-sheet) layers (612, 614, 616, 618, 620, 622) that have been laminated and sintered together to form a substantially monolithic structure. The MMD 610 includes a cavity 624 that is connected to a first channel 626 and a second channel 628. The first channel 626 is also connected to a first via 630, which is connected to a second via 632 that defines a first fluid port 634. The second channel 628 is connected to a third via 636 that defines a second fluid port 638. In this way, the cavity 624 is in fluid communication with the first fluid port 634 and the second fluid port 638. More particularly, the first via 630, the second via 632, the first channel 626, the cavity 624, the second channel 628, and the third via 636 define a fluid passageway interconnecting the first fluid port 634 and the second fluid port 638. In this configuration, the first fluid port 634 and the second fluid port 638 can be used as fluid input or output ports to add reactants and/or remove products, with the cavity 624 providing a reaction container.

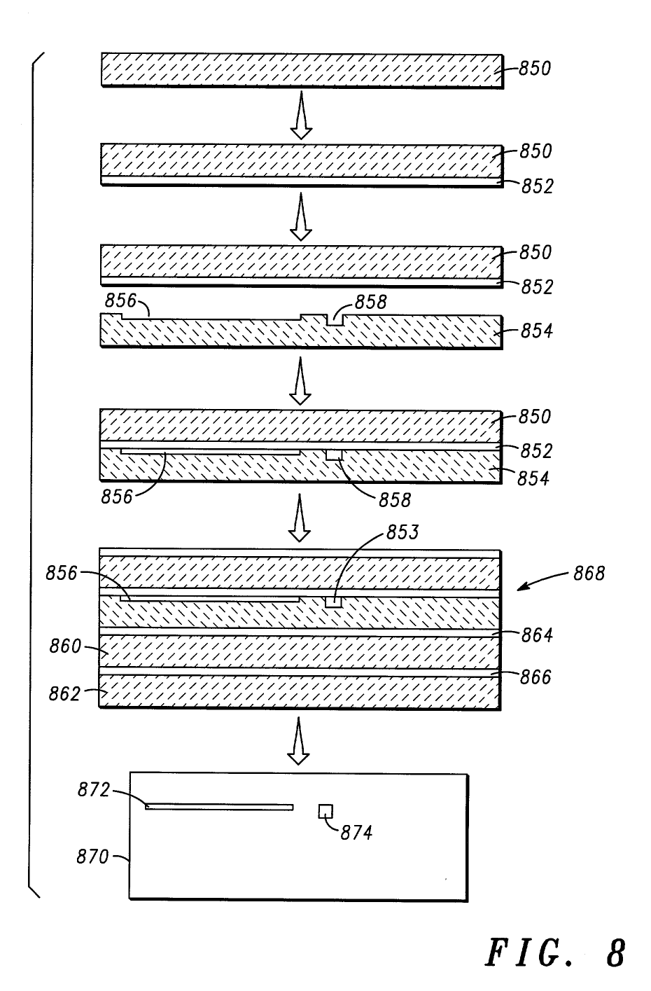

Referring to FIGS. 7A-7F, the COR patterned ceramic layers (612, 614, 616, 618, 620, 622) of FIG. 6 are shown before lamination to provide the aforementioned fluid passageway interconnecting the first fluid port 634 and the second fluid port 636. As shown in FIG. 7A, the first COR patterned ceramic layer 612 has the second via 632 and the third via 636. As shown in FIG. 7B, the second COR patterned ceramic layer 614 has the first via 630 and a portion of the cavity 624 connected to the channel 628. As shown in FIG. 7C, the third COR patterned ceramic layer 616 has a portion of the cavity 624 connected to the channel 626. As shown in FIG. 7D, the fourth COR patterned layer 618 has a portion of the cavity 624. The fifth COR patterned layer 618 and the sixth COR patterned layer 622 shown in FIGS. 7E and 7F, respectively, have no such structures.

As previously discussed in this detailed description of preferred embodiments, a multilayered ceramic device is preferably formed from the multiple COR patterned ceramic layers and further processing conducted in order to accomplish this formation. As can be appreciated by one of ordinary skill in the art, a wide variety of materials can be applied to each of the COR patterned ceramic layers (612, 614, 616, 618, 620, 622). For example, depositing metal-containing thick-film pastes onto the COR patterned ceramic layers (612, 614, 616, 618, 620, 622) can provide electrically conductive pathways. The thick-film pastes typically include the desired material, which can be a metal and/or a dielectric that is preferably in the form of a powder dispersed in an organic vehicle, and the pastes are preferably designed to have the viscosity appropriate for the desired deposition technique, such as screen-printing. The organic vehicle can include resins, solvents, surfactants, and flow-control agents, for example. The thick-film paste can also include a small amount of a flux, such as a glass frit, to facilitate sintering. The thick-film technology and application for forming a MMD is further described in the Integrated MMD reference, J. D. Provance, “Performance Review of Thick Film Materials,” Insulation/Circuits (April, 1977), and Morton L. Topfer, Thick Film Microelectronics, Fabrication, Design, and Applications (1977), pp. 41-59, which are incorporated herein by reference.

In certain applications, the addition of glass coatings to the surfaces of the COR patterned ceramic layers is desirable. The glass coatings can provide smooth walls in the fluid passageways. Glass coatings can also serve as barriers between the fluid and the ceramic layer materials that may be reactive or otherwise incompatible with the fluid. The methods to add glass coatings to the surfaces of the ceramic layers are described in the Integrated MMD reference.

Many other materials can be added to the COR patterned ceramic layers to provide the desired functionalities previously discussed in this detailed description of preferred embodiments and the Integrated MMD reference. For example, optical materials can be added to provide optical windows. In addition, piezoelectric materials can also be added to provide piezoelectric members. Furthermore, thermoelectric materials can be added to provide thermoelectric elements and high magnetic permeability materials, such as ferrites, can be added to provide cores for strong electromagnets.

The materials of the COR patterned ceramic layers preferably have a great deal of flexibility to accommodate the addition of dissimilar materials. To ensure that the materials are reliably arranged in the multilayered ceramic device, it is preferable that the materials added to the COR patterned ceramic layers are co-firable with the ceramic layer material. More specifically, after the desired structures are formed in each of the COR patterned ceramic layers, an adhesive layer is preferably applied to either surface of each of the COR patterned ceramic layers. This technique is described in Integrated MMD reference. After the adhesive has been applied to the COR patterned ceramic layers, the COR patterned ceramic layers are stacked together to form the multilayered ceramic structure. Preferably, the COR patterned ceramic layers are stacked in an alignment die to maintain the registration between the recessed patterns of the COR patterned ceramic layers. When an alignment die is used in accordance with a preferred exemplary embodiment of the present invention, alignment holes are preferably added to the COR patterned ceramic layers to assist in the registration.

Typically, the stacking process is sufficient to bind the COR patterned ceramic layers when a room-temperature adhesive is applied to the COR patterned ceramic layers. In other words, minimal pressure is utilized to bind the COR patterned ceramic layers. However, in order to improve the binding of the COR patterned ceramic layers, lamination is conducted after the stacking process. The lamination process preferably involves the application of pressure to the stacked COR patterned ceramic layers. The lamination methods of the preferred exemplary embodiment of the present invention are described in the Integrated MMD reference.

As with semiconductor device fabrication, many devices can be present with each COR patterned ceramic layer. Accordingly, the multilayered structure may be diced after lamination using conventional ceramic layer dicing or sawing apparatus to separate the individual devices. The high levels of peel and shear resistance provided by the adhesive results in the occurrence of very little edge delamination during the dicing process. If some layers become separated around the edges after dicing, the layers may be easily re-laminated by applying pressure to the affected edges, without adversely affecting the remainder of the device.

The final processing step is firing to convert the laminated multilayered ceramic structure from its “green” state to form the finished, substantially monolithic, multilayered structure. The firing process preferably occurs in two stages. The first stage is the binder burnout stage that occurs in the temperature range of about two hundred and fifty degrees Celsius (250° C.) to five hundred degrees Celsius (500° C.), during which the organic materials, such as the binder in the COR patterned ceramic layers and the organic components in any applied thick-film pastes, are removed from the structure.

Once the first step is complete, the second stage is initiated, which is generally referred to as the sintering stage. The sintering stage generally occurs at a higher temperature than the first state, and the inorganic particles sinter together so that the multilayered structure is densified and becomes substantially monolithic. The sintering temperature depends on the nature of the inorganic particles present in the COR patterned ceramic layers. For many types of ceramics, appropriate sintering temperatures range from about nine hundred and fifty degrees Celsius (950° C.) to about sixteen hundred degrees Celsius (1600° C.), depending on the material. For example, for a COR patterned ceramic layer containing aluminum oxide, sintering temperatures between about fourteen hundred degrees Celsius (1400°) and about sixteen hundred degrees Celsius (1600° C.) are typical. Other ceramic materials, such as silicon nitride, aluminum nitride, and silicon carbide, require higher sintering temperatures. For example, silicon nitride, aluminum nitride and silicon carbide have sintering temperatures of about seventeen hundred degrees Celsius (1700° C.) to twenty-two hundred degrees Celsius (2200° C.). For a COR patterned ceramic layer with glass-ceramic particles, a sintering temperature in the range of about seven hundred and fifty degrees Celsius (750° C.) to about nine hundred and fifty degrees Celsius (950° C.) is typical. Glass particles generally require sintering temperatures in the range of only about three hundred and fifty degrees Celsius (350° C.) to about seven hundred degrees Celsius (700° C.). Finally, metal particles may require sintering temperatures from about five hundred and fifty degrees Celsius (550° C.) to about seventeen hundred degrees Celsius (1700° C.), depending on the metal.

Typically, the firing is conducted for a period of about four hours to about twelve hours or more, depending on the material. The firing should be of a sufficient duration so as to substantially remove the organic materials from the structure and to sinter substantially all the inorganic particles. In particular, firing should be at a sufficient temperature and duration to decompose polymers and to allow for removal of the polymers from the multilayered structure.

Typically, the multilayered structure undergoes a reduction in volume during the firing process. For example, a small volume reduction of about one-half to about one and one-half percent (i.e., 0.5% to 1.5%) is normally observed during the binder burnout phase. At higher temperatures as preferably used during the sintering stage, a further volume reduction of about fourteen to about seventeen percent (i.e., 14% to 17%) is typically observed during the binder burnout phase.

As previously described in this detailed description of preferred embodiments, dissimilar materials added to the COR patterned ceramic layers are preferably co-fired with the COR patterned ceramic layers. The dissimilar materials can be added as thick-film pastes or as other COR patterned ceramic layers. The benefit of co-firing is that the added materials are sintered to the COR patterned ceramic layers and the added materials become an integral component of the substantially monolithic multilayered ceramic device. However, the added materials should have sintering temperatures and volume changes due to firing that are substantially matched with those of the COR patterned ceramic layers. The sintering temperatures are largely material-dependent, so that substantially matching sintering temperatures can be accomplished with proper selection of materials. For example, although silver is the preferred metal for providing electrically conductive pathways, if the COR patterned ceramic layers contain alumina particles, which require a sintering temperature in the range of about fourteen hundred degrees Celsius (1400° C.) to about sixteen hundred degrees Celsius (1600° C.), some other metal, such as platinum, is preferably used due to the relatively low melting point of silver, which is about nine hundred and sixty one degrees Celsius (961° C.).

The volume change due to firing is preferably controlled according to a preferred exemplary embodiment of the present invention. In particular, to match volume changes in two materials, such as a COR patterned ceramic layer and a thick-film paste, the particle sizes and the percentage of organic components, such as binders, which are removed during the firing process, are preferably matched in accordance with the present invention. However, the match of the volume change does not need to be exact, but any mismatch will typically result in internal stresses in the device and the greater the mismatch, the greater the internal stress. Symmetrical processing, which involves placing a substantially identical material or structure on opposite sides of the device can compensate for shrinkage mismatched materials.

Referring to FIG. 8, an illustration of the preceding steps for forming a MMD is provided according to a preferred exemplary embodiment of the present invention. Initially, a first COR patterned ceramic layer 850 is provided with an appropriate size for further processing. A room-temperature adhesive layer 852 is applied to one surface of the first COR patterned ceramic layer 850. The first COR patterned ceramic layer 850 is then stacked with a second COR patterned ceramic layer 854 having a first internal channel 856 and a second internal cavity 888. The first COR patterned ceramic layer 850 and the second COR patterned ceramic layer 854 are stacked with a third COR patterned ceramic layer 860 and a fourth COR patterned ceramic layer 862 and a first room-temperature adhesive 864 and a second room-temperature adhesive 866 are applied to form the complete multilayered ceramic structure 868. The multilayered ceramic structure 868 is laminated as previously described in this detailed description of a preferred exemplary embodiment and fired to form the final substantially monolithic structure 870.

The use of near-zero pressures (i.e., pressures less than one hundred psi) for lamination is preferable as near-zero pressures tend to maintain the integrity of internal structures and enable the internal channel 856 and the internal cavity 858 formed in the second COR patterned ceramic layer 854 to remain as an internal channel 872 and an internal cavity 874, respectively, in the final substantially monolithic structure 870. However, other lamination processes, including conventional high-pressure lamination process, can also be used in accordance with the present invention, albeit with less control over the dimensions of internal structures. In addition, each of the COR patterned ceramic layers do not need to be laminated at near-zero pressures. More specifically, COR patterned ceramic layers that do not contain structures or materials that would be damaged or deformed by high pressures can be laminated conventionally, and this resulting structure can be laminated to other COR patterned ceramic layers using near-zero pressure lamination. An example of such a process is described in the Integrated MMD reference.

From the foregoing description, it should be appreciated that simple and cost effective methods and apparatus are provided to form recessed patterns in green-sheets and multilayered ceramic devices that present benefits that have been presented in the foregoing background of invention and detailed description of preferred embodiments and also presents benefits that would be apparent to one of ordinary skilled in the art. Furthermore, while preferred exemplary embodiments have been presented in the foregoing detailed description of preferred embodiments, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. It being understood that various changes may be made in the function and arrangement of elements described in the exemplary preferred embodiment without departing from the spirit and scope of the invention as set forth in the appended claims.

What is claimed is:

1. A method of forming a ceramic layer with a pattern for use in a multilayered ceramic device, comprising:
depositing a layer of sensitive material on a substrate;
selectively exposing said layer of sensitive material to a radiation source such that a first portion of said layer of sensitive material having a positive image of the pattern is soluble in a solvent and a second portion of said layer of sensitive material having a negative image of the pattern is insoluble in said solvent;
immersing said layer of sensitive material in said solvent to remove said first portion of said layer of sensitive material to form a casting substrate having said negative image of the pattern provided by said second portion of said layer of sensitive material;
connecting said casting substrate to a transporting apparatus;
applying ceramic slurry on said casting substrate with an application apparatus as said transporting apparatus transports said casting substrate;
curing said ceramic slurry on said casting substrate with a curing apparatus as said transporting apparatus transports said casting substrate; and
separating said ceramic slurry from said casting substrate after said curing with a separation apparatus such that the ceramic layer with the pattern is formed for use in a multilayered ceramic device.

2. The method of claim 1, wherein
said transporting apparatus is comprised of a tape casting substrate connected to a tape casting apparatus that is configured to transport said tape casting substrate and said casting substrate connected to said tape casting substrate; and
said substrate and said tape casting substrate are selected from the group consisting of MYLAR®, polyethylene, polypropylene and tape-casting paper.

3. The method of claim 1, wherein said application apparatus is a curtain-coating machine.

4. The method of claim 1, wherein said application apparatus is comprised of a doctor blade.

5. The method of claim 1, wherein said selectively exposing said layer of sensitive material to a radiation source comprises:
placing a mask between said radiation source and said resist, said mask having an opaque region and a transparent region; and
activating said radiation source such that said second portion below said transparent region is exposed to said radiation source.

6. The method of claim 1, further comprising applying a release layer on at least part of said casting substrate.

7. The method of claim 1, wherein said ceramic slurry is a composite having ceramic particles and inorganic particles.

8. The method of claim 1, wherein said curing said ceramic slurry on said casting substrate includes utilization of a curable binder.

9. The method of claim 8, wherein said curable binder is an acrylate monomer.

10. The method of claim 1, wherein the separating apparatus is a vacuum table.

11. The method of claim 1, further comprising leveling the top surface of said cured ceramic slurry on said casting substrate with a plastic deformation method.

12. The method of claim 1, wherein said pattern is a partially recessed pattern.

13. The method of claim 1, wherein said pattern extends through the thickness of the ceramic layer.

14. The method of claim 1, wherein said pattern forms at least part of a micro feature selected from the group consisting of a channel, a via and a cavity.

15. A method of forming a ceramic layer with a pattern for use in a multilayered ceramic device, comprising:
connecting a line substrate to a tape casting apparatus that is configured to transport said line substrate;
depositing a layer of sensitive material on said line substrate;
selectively exposing said layer of sensitive material on said line substrate to a radiation source such that a first portion of said layer of sensitive material having a positive image of the pattern is soluble in a solvent and a second portion of said layer of sensitive material having a negative image of the pattern is insoluble in said solvent as said transporting apparatus transports said line substrate;
immersing said layer of sensitive material on said line substrate in said solvent to remove said first portion of said layer of sensitive material to form a casting substrate within said line substrate having said negative image of the pattern provided by said second portion of said layer of sensitive material as said transporting apparatus transports said line substrate;
applying ceramic slurry on said casting substrate by an application apparatus as said transporting apparatus transports said line substrate;
curing said ceramic slurry on said casting substrate with a curing apparatus as said transporting apparatus transports said line substrate; and
removing said ceramic slurry from said casting substrate after said curing such that the ceramic layer with the pattern is formed for use in a multilayered ceramic device.

16. The method of claim 15, wherein said application apparatus is a curtain-coating machine.

17. The method of claim 15, wherein said application apparatus is comprised of a doctor blade.

18. The method of claim 15, wherein said line substrate is stainless steel and further comprising of applying a release layer to the stainless steel before depositing said layer of sensitive material on said line substrate.

19. The method of claim 15, further comprising applying a release layer on at least part of said casting substrate.

20. The method of claim 15, wherein said curing said ceramic slurry on said casting substrate includes utilization of a curable binder.

21. The method of claim 20, wherein said curable binder is an acrylate monomer.

22. The method of claim 15, wherein said separation apparatus is a vacuum table.

23. The method of claim 15, further comprising leveling the top surface of said cured ceramic slurry on said casting substrate with a plastic deformation method.

24. The method of claim 15, wherein said pattern is a partially recessed pattern.

25. The method of claim 15, wherein said pattern extends through the thickness of the ceramic layer.

26. The method of claim 15, wherein said pattern forms at least part of a micro feature selected from the group consisting of a channel, a via and a cavity.

27. A method for making a multilayered ceramic device, comprising:
forming a first ceramic layer;
forming a second ceramic layer having a pattern, said forming said second ceramic layer having said pattern comprising:
depositing a layer of sensitive material on a substrate;
selectively exposing said layer of sensitive material to a radiation source such that a first portion of said layer of sensitive material having a positive image of the pattern is soluble in a solvent and a second portion of said layer of sensitive material having a negative image of the pattern is insoluble in said solvent;
immersing said layer of sensitive material in said solvent to remove said first portion of said layer of sensitive material to form a casting substrate having said negative image of the pattern provided by said second portion of said layer of sensitive material;
connecting said casting substrate to a transporting apparatus;
applying ceramic slurry which is a composite having ceramic particles and inorganic particles on said casting substrate with an application apparatus as said transporting apparatus transports said casting substrate;
curing said ceramic slurry on said casting substrate with a curing apparatus as said transporting apparatus transports said casting substrate; and
separating said ceramic slurry from said casting substrate after said curing to produce said second ceramic layer;
affixing said first ceramic layer to said second ceramic layer; and
sintering said first ceramic layer and said second ceramic layer.

28. The method of claim 27, wherein
said transporting apparatus is comprised of a tape casting substrate connected to a tape casting apparatus that is configured to transport said tape casting substrate and said casting substrate connected to said tape casting substrate; and
said substrate and said tape casting substrate are selected from the group consisting of MYLAR®, polyethylene, polypropylene and tape-casting paper.

29. The method of claim 27, wherein said application apparatus is a curtain-coating machine.

30. The method of claim 27, wherein said application apparatus is comprised of a doctor blade.

31. The method of claim 27, further comprising applying a release layer on at least part of said casting substrate.

32. The method of claim 27, wherein said curing said ceramic slurry on said casting substrate includes utilization of a curable binder.

33. The method of claim 27, wherein the separating apparatus is a vacuum table.

34. The method of claim 27, further comprising leveling the top surface of said cured ceramic slurry on said casting substrate with a plastic deformation method.

35. The method of claim 27, wherein said multilayered ceramic device has at least one micro feature selected from the group consisting of a channel, a via and a cavity.

36. The method of claim 27, wherein said multilayered ceramic device has at least one component selected from the group consisting of a heater, a thermoelectric element, a heterogeneous catalyst, a capacitive sensor, a resistive sensor, an inductive sensor, a optical sensor, a temperature sensor, a pH sensor, an electroosmotic pump, an electrohydrodynamic pump, a piezoelectric member, and an electromagnet.

37. The method of claim 27, wherein said multilayered ceramic device is a multilayered microfluidic device.

38. A method for making a multilayered ceramic device, comprising:
forming a first ceramic layer;
forming a second ceramic layer having a pattern, said forming said second ceramic layer having said pattern comprising:
connecting a line substrate to a tape casting apparatus that is configured to transport said line substrate;
depositing a layer of sensitive material on said line substrate;
selectively exposing said layer of sensitive material on said line substrate to a radiation source such that a first portion of said layer of sensitive material having a positive image of the pattern is soluble in a solvent and a second portion of said layer of sensitive material having a negative image of the pattern is insoluble in said solvent as said transporting apparatus transports said line substrate;
immersing said layer of sensitive material on said line substrate in said solvent to remove said first portion of said layer of sensitive material to form a casting substrate within said line substrate having said negative image of the pattern provided by said second portion of said layer of sensitive material as said transporting apparatus transports said line substrate;
applying ceramic slurry which is a composite having ceramic particles and inorganic particles on said casting substrate by an application apparatus as said transporting apparatus transports said line substrate;
curing said ceramic slurry on said casting substrate with a curing apparatus as said transporting apparatus transports said line substrate; and
removing said ceramic slurry from said casting substrate after said curing to produce said second ceramic layer;
affixing said first ceramic layer to said second ceramic layer; and
sintering said first ceramic layer and said second ceramic layer.

39. The method of claim 38, wherein said application apparatus is a curtain-coating machine.

40. The method of claim 38, further comprising applying a release layer on at least part of said casting substrate.

41. The method of claim 38, wherein said curing said ceramic slurry on said casting substrate includes utilization of a curable binder.

42. The method of claim 38, further comprising leveling the top surface of said cured ceramic slurry on said casting substrate with a plastic deformation method.

43. The method of claim 38, wherein said multilayered ceramic device has at least one micro feature selected from the group consisting of a channel, a via and a cavity.

44. The method of claim 38, wherein said multilayered ceramic device has at least one component selected from the group consisting of a heater, a thermoelectric element, a heterogeneous catalyst, a capacitive sensor, a resistive sensor, an inductive sensor, a optical sensor, a temperature sensor, a pH sensor, an electroosmotic pump, an electrohydrodynamic pump, a piezoelectric member, and an electromagnet.

45. The method of claim 38, wherein said multilayered ceramic device is a multilayered microfluidic device.
